(19) United States
(12) Patent Application Publication
(10) Pub. No.: US 2018/0010468 A1
(43) Pub. Date: Jan. 11, 2018

(54) ENHANCED TEMPERATURE CAPABILITY GAMMA TITANIUM ALUMINUM ALLOYS

(71) Applicant: UNITED TECHNOLOGIES CORPORATION, Farmington, CT (US)

(72) Inventor: Gopal Das, Simsbury, CT (US)

(21) Appl. No.: 15/204,162

(22) Filed: Jul. 7, 2016

(51) Int. Cl. F01D 5/28; C22C 14/00

(52) U.S. Cl. CPC F01D 5/28; C22C 14/00; F05D 2300/174

(57) ABSTRACT

An alloy composition including a γ-TiAl alloy with a sustained temperature capability of about 1500 F. An alloy composition including a γ-TiAl alloy with an oxygen level of about 100 wppm and between about 1500-3000 appm carbon. An alloy composition including a γ-TiAl alloy with an alpha stabilizer.

### BACKGROUND

The present disclosure relates to enhanced temperature capability gamma-TiAl alloys.

Two-phase γ-TiAl alloys are attractive for high temperature structural applications due to their low density, good elevated temperature mechanical properties, and oxidation and burn resistance. This class of material has the potential to withstand the demanding conditions to which aircraft engines, space vehicles, and automotive engines are typically exposed. Two-phase γ-TiAl alloys have significant potential for use in advanced gas turbine engines, replacing twice-heavier superalloys at temperatures above 1500 F.

Recently, a new beta-stabilized γ-TiAl alloy, TNM, has undergone critical evaluation for gas turbine engine applications such as low pressure turbine (LPT) blade applications. The TNM alloy has the chemical composition Ti-(42-44) Al-5 (Nb, Mo)-0.1 B (all in at %) with oxygen at about 800 wppm and solidifies through the beta solidification path yielding a fine cast microstructure with low segregation and minor texture.

Vacuum Arc Melting (VAM) cast microstructure is characterized by predominantly lamellar colonies with small amount of gamma and about 10 volume fraction of b/B2 (ω) phase. The strength of as-cast TNM and other conventional cast gamma alloys is too low to fulfill the strength needed for the certain components such as high speed LPT blades. However, in the wrought condition, the TNM alloy can meet the strength goal. The cast structure is commonly broken down by extrusion/and isothermal forging or by isothermal forging alone which is followed by heat treatments to produce microstructures ranging from a duplex microstructure consisting of γ phase and lamellar colonies (alpha2+γ) to a fully lamellar microstructure with varying amounts of b/B2 (ω).

The high speed LPT blades require a room temperature ductility of about 1.5-3% and tensile strength of about 130-140 ksi along with creep resistance at about 1400 F. Suitable heat treatment of optimum duplex microstructure can fulfill ductility, strength and creep requirements for the high speed LPT blade application. It has been determined that in the wrought condition the maximum use temperature for TNM alloy is 1400 F.

### SUMMARY

A rotor blade according to one disclosed non-limiting embodiment of the present disclosure can include a γ-TiAl alloy with a sustained temperature capability of about 1500 F.

A further embodiment of the present disclosure may include, wherein the γ-TiAl alloy includes an oxygen level of about 100 wppm and between about 1500-3000 appm carbon.

A further embodiment of the present disclosure may include, wherein the γ-TiAl alloy includes an alpha stabilizer.

A further embodiment of the present disclosure may include, wherein the alpha stabilizer includes a carbon.

A further embodiment of the present disclosure may include, wherein alpha stabilizer is operable to reduce the potency of the beta stabilizing elements.

A further embodiment of the present disclosure may include, wherein the rotor blade is a low pressure turbine (LPT) blade.

An alloy composition according to one disclosed non-limiting embodiment of the present disclosure can include a γ-TiAl alloy with an alpha stabilizer.

A further embodiment of the present disclosure may include, wherein the alpha stabilizer includes a carbon.

A further embodiment of the present disclosure may include, wherein the γ-TiAl alloy has a sustained temperature capability of about 1500 F.

An alloy composition according to one disclosed non-limiting embodiment of the present disclosure can include a γ-TiAl alloy with an oxygen level of about 100 wppm and between about 1500-3000 appm carbon.

A further embodiment of the present disclosure may include, wherein the γ-TiAl alloy includes silicon.

A further embodiment of the present disclosure may include, about 0.1-0.2% silicon.

The foregoing features and elements may be combined in various combinations without exclusivity, unless expressly indicated otherwise. These features and elements as well as the operation thereof will become more apparent in light of the following description and the accompanying drawings. It should be understood, however, the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiments. The drawings that accompany the detailed description can be briefly described as follows:

FIG. 1 is a schematic view of an example component manufactured of a TNM alloy.

FIG. 2A is a microstructure of extruded, forged and heat treated TNM creep specimen showing loss of b/B2 phase during creep at 1472 F/35 ksi in a Grip section near fracture;

FIG. 2B is a microstructure of extruded, forged and heat treated TNM creep specimen showing loss of b/B2 phase during creep at 1472 F/35 ksi in a Gage section near fracture;

FIG. 3A is a micrographs of the microstructure of an as cast TNM alloy;

FIG. 3B is a micrographs of the microstructure of an as cast TNM alloy showing a drastic reduction of b/B2 phase with addition of only 0.3 atomic % C;

FIG. 3C is a micrograph of the microstructure of an as cast TNM alloy showing a drastic reduction of b/B2 phase with addition of only 0.5 atomic % C;

FIG. 4A is a micrograph of a microstructure of fine precipitates at dislocations in the matrix of 0.5 atomic % carbon containing TNM alloy.

FIG. 4B is a micrograph of a microstructure of fine precipitates at dislocations in the matrix of 0.5 atomic % carbon containing TNM alloy in which stacking, fault-like structure is observed in 1 atomic % carbon containing TNM alloy.

### DETAILED DESCRIPTION

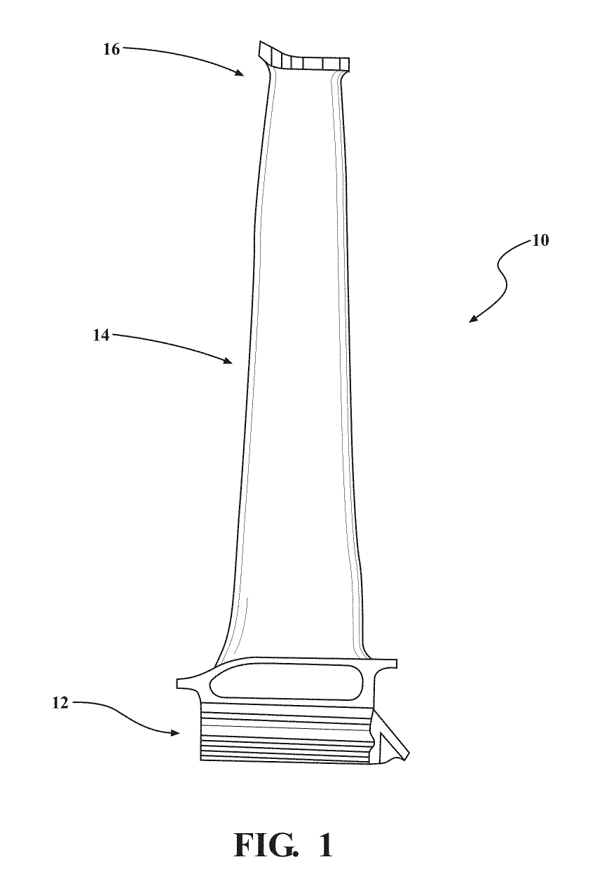

With reference to FIG. 1, a schematic diagram of an example component such as a low pressure turbine (LPT) rotor blade 10 with a root 12, an airfoil 14, and a shroud 16 section. The blade 10 has a relatively complex geometry and, as a result, cannot be easily fabricated. A number of process routes, incorporating both cast and wrought processes, may be utilized to fabricate low pressure turbine (LPT) gamma TiAl blades. For the cast process, investment mold casting is typically used to make oversized blade blanks that are then machined into final blades. The wrought process involves both extrusion and forging which provides creep deformation prior to machining.

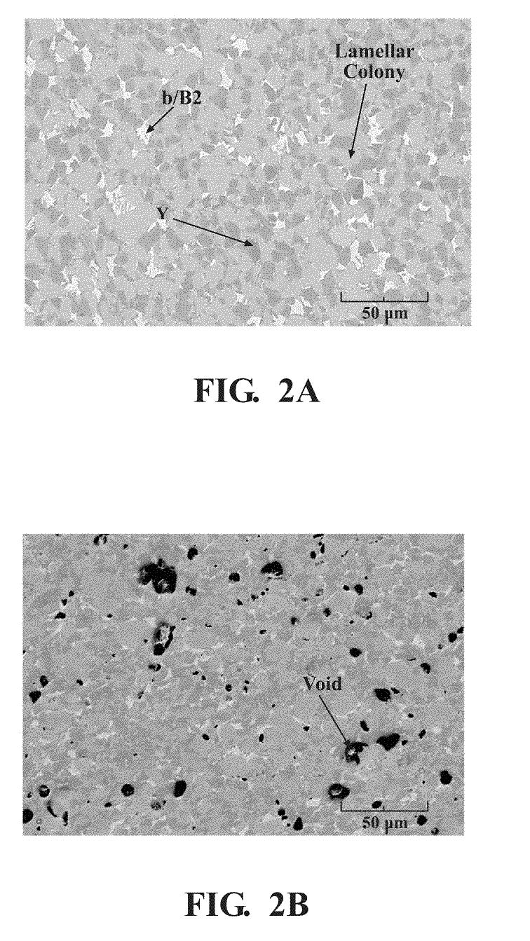

During creep deformation, the matrix microstructure of the TNM alloy becomes increasingly unstable with increasing temperature and stress. Typically, the lamellar structure starts to coarsen while the volume fraction of b/B2 phase decreases. An example of loss of b/B2 phase in wrought TNM during creep at 1472 F/35 ksi is shown in FIG. 2A. FIG. 2A is a back-scattered SEM image taken from the grip section of a failed sample while the BSE image in FIG. 2B represents the gage section near fracture. The loss of b/B2 from 6% at the grip to 3% at the gage section is readily observed in FIG. 2B. That is, the b/B2 phase in the matrix should be lowered to improve creep resistance.

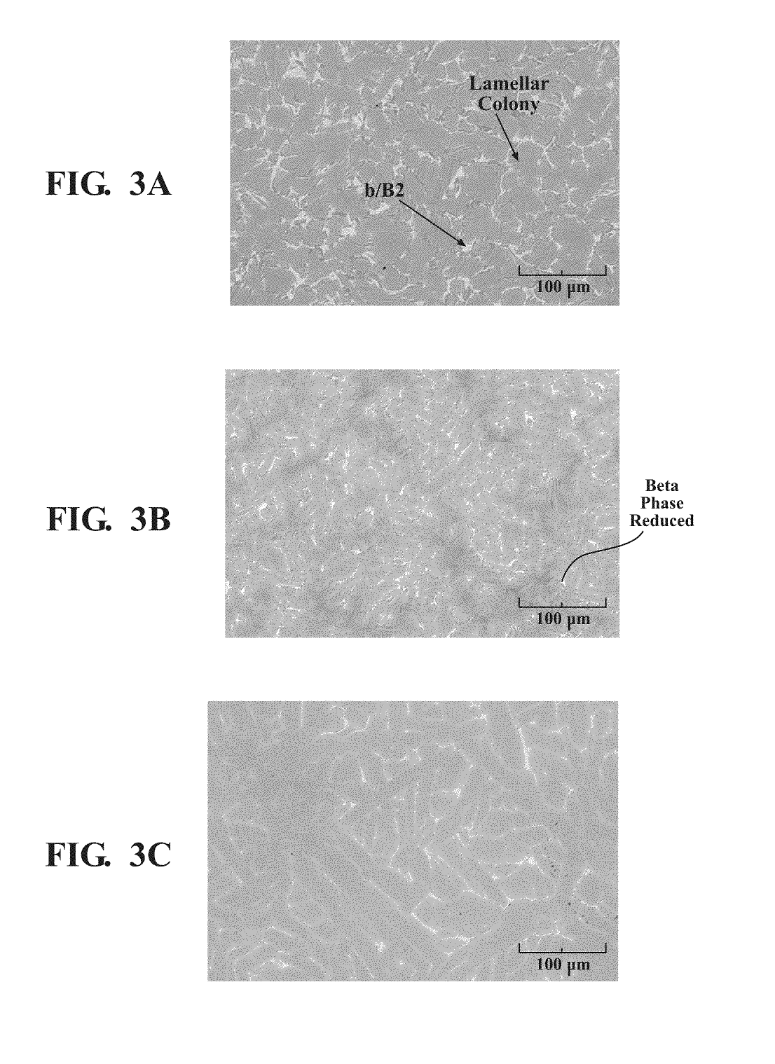

One disclosed non-limiting embodiment of a process to increase the temperature capability of a γ-TiAl alloys such as TNM to about 1500 F without sacrificing room temperature ductility is effectuated via the addition of minor amounts of alpha stabilizer such as carbon in the existing TNM alloy to reduce the potency of the beta stabilizing elements in TNM alloy and thereby result in a reduction of b/B2 phase as shown in FIGS. 3A-3C.

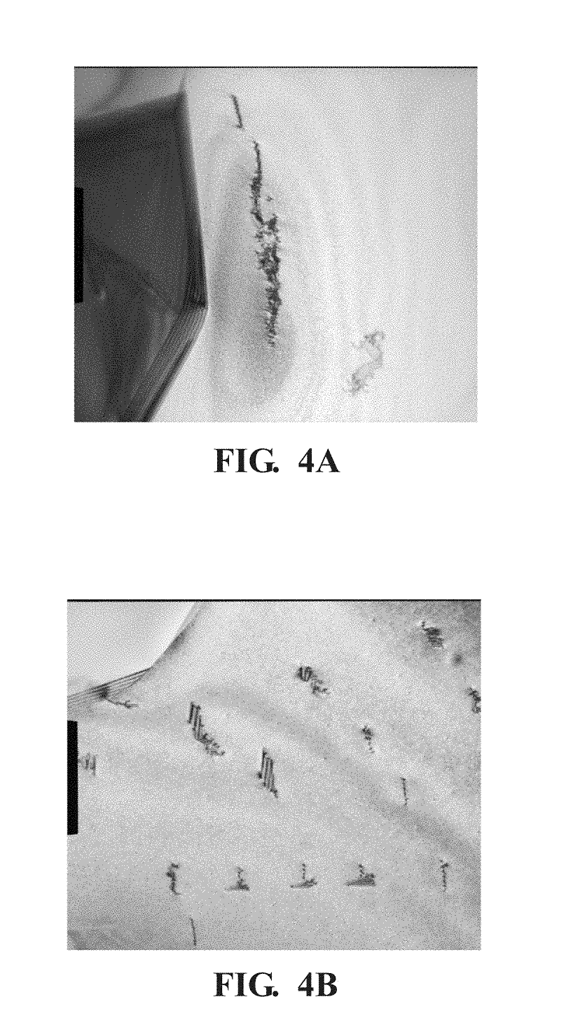

Although carbon may improve creep resistance in gamma alloys, carbon has very low solubility in γ-TiAl alloys and may lower the ductility thereof. A relatively small amount of carbon is that within the solubility limit of the alloy. Carbon addition in excess of the solubility limit may lead to the formation of precipitates (presumably some form of titanium carbide) as shown in FIG. 4A-4B. At 0.5 atomic % carbon, a few fine precipitates appear at the dislocations in the matrix and thereafter more and more such precipitates appear. Further, numerous stacking fault-like structure may occur in the TNM alloy with 1 atomic % C which was not present in the virgin TNM alloy (FIG. 4B).

Thus, during creep deformation, some form of carbide precipitations will occur which will pin the dislocations and thereby increasing resistance to dislocation motion and improving the creep capability. Creep induced precipitation has been reported in various alloys. Additionally, the stacking fault-like structure resulting from the addition of carbon may also become obstacles to dislocation motion and thereby improving the creep capability of the alloy.

It is expected that reduced volume fraction of b/B2 phase, creep induced carbide precipitation, and formation of stacking fault-like structure brought about by addition of small amount of carbon in the TNM alloy, may extend the temperature capability by about 100 F (to about 1500 F) over conventional TNM capability through improved creep resistance without adversely affecting ductility.

Another disclosed non-limiting embodiment of a process to increase the temperature capability of a γ-TiAl alloys such as TNM to about 1500 F without sacrificing room temperature ductility is effectuated via the reduction of Interstitials such as oxygen, nitrogen, and carbon. The commercially available TNM alloy has ˜800 wppm oxygen and ductility at room temperature increased with decreasing oxygen content in cast γ-TiAl.

In one example, oxygen reduction from 1500 wppm to 500 wppm results in a significant improvement in ductility from 0.5% to 1.5% at room temperature. Cast and HIP′d TNM γ-TiAl alloy has exhibited a similar trend in that by lowering oxygen level from 800 wppm to 500 wppm, the room temperature ductility has increased from 0.8% for 800 wppm oxygen to 1% for 500 wppm oxygen along with a 20% increase in tensile strength.

In this disclosed non-limiting embodiment, oxygen and other interstitials are reduced from 500 wppm to about 100 wppm in the cast TNM alloy which further improves ductility at room temperature. For temperature improvement, carbon is added to this low oxygen TNM alloy that may lead to a slight loss of ductility. It is expected that the overall ductility by lowering oxygen level to ˜100 wppm and adding carbon (1500-3000 appm) will provide an improvement over TNM alloy with 800 wppm oxygen.

Although the conventional TNM alloy does not show evidence of oxidation up to 1400 F, as the temperature of TNM alloy is increased to 1500 F by using very low oxygen containing TNM alloy with small addition of carbon, the TNM alloy according to the disclosed non-limiting embodiment may require protection against oxidation above 1400 F. The TNM alloy according to the disclosed non-limiting embodiment may includes a relatively small amount of silicon, such as, for example, 0.1-0.2% silicon to boost oxidation resistance in the new low oxygen, low carbon TNM alloy.

Improvements to increase the temperature capability of the present TNM alloy to 1500 F without sacrificing room temperature ductility may further facilitate applications in gas turbine engines through replacement of relatively twice heavier nickel-based superalloys.

The use of the terms “a,” “an,” “the,” and similar references in the context of description (especially in the context of the following claims) are to be construed to cover both the singular and the plural, unless otherwise indicated herein or specifically contradicted by context. The modifier “about” used in connection with a quantity is inclusive of the stated value and has the meaning dictated by the context (e.g., it includes the degree of error associated with measurement of the particular quantity). All ranges disclosed herein are inclusive of the endpoints, and the endpoints are independently combinable with each other. It should be appreciated that relative positional terms such as “forward,” “aft,” “upper,” “lower,” “above,” “below,” and the like are with reference to normal operational attitude and should not be considered otherwise limiting.

Although the different non-limiting embodiments have specific illustrated components, the embodiments of this invention are not limited to those particular combinations. It is possible to use some of the components or features from any of the non-limiting embodiments in combination with features or components from any of the other non-limiting embodiments.

It should be appreciated that like reference numerals identify corresponding or similar elements throughout the several drawings. It should also be appreciated that although a particular component arrangement is disclosed in the illustrated embodiment, other arrangements will benefit herefrom.

Although particular step sequences are shown, described, and claimed, it should be understood that steps may be performed in any order, separated or combined unless otherwise indicated and will still benefit from the present disclosure.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be understood that within the scope of the appended claims, the disclosure may be practiced other than as specifically described. For that reason the appended claims should be studied to determine true scope and content.

What is claimed:

1. A rotor blade, comprising:
a γ-TiAl alloy with a sustained temperature capability of about 1500 F.

2. The rotor blade as recited in claim 1, wherein the γ-TiAl alloy includes an oxygen level of about 100 wppm and between about 1500-3000 appm carbon.

3. The rotor blade as recited in claim 1, wherein the γ-TiAl alloy includes an alpha stabilizer.

4. The rotor blade as recited in claim 3, wherein the alpha stabilizer includes a carbon.

5. The rotor blade as recited in claim 3, wherein alpha stabilizer is operable to reduce the potency of the beta stabilizing elements.

6. The rotor blade as recited in claim 1, wherein the rotor blade is a low pressure turbine (LPT) blade.

7. An alloy composition, comprising:
a γ-TiAl alloy with an alpha stabilizer.

8. The alloy as recited in claim 7, wherein the alpha stabilizer includes a carbon.

9. The alloy as recited in claim 7, wherein the γ-TiAl alloy has a sustained temperature capability of about 1500 F.

10. An alloy composition, comprising:
a γ-TiAl alloy with an oxygen level of about 100 wppm and between about 1500-3000 appm carbon.

11. The alloy as recited in claim 10, wherein the γ-TiAl alloy includes silicon.

12. The alloy as recited in claim 10, further comprising about 0.1-0.2% silicon.
